(19) United States
(12) Patent Application Publication
(10) Pub. No.: US 2010/0014482 A1
(43) Pub. Date: Jan. 21, 2010

(54) RADIO BASE STATION AND RADIO COMMUNICTION SYSTEM FOR STARTING INTER-SYSTEM HANDOFF

(76) Inventors: Norihisa Matsumoto, Fuchu (JP); Yosuke Takahashi, Yokohama (JP)

Correspondence Address: BRUNDIDGE & STANGER, P.C., 1700 DIAGONAL ROAD, SUITE 330, ALEXANDRIA, VA, 22314, US

(21) Appl. No.: 12/300,020

(22) PCT Filed: Jan. 9, 2007
(86) PCT No.: PCT/JP2007/050086

§ 371 Date: Feb. 24, 2009

(30) Foreign Application Priority Data
May 10, 2006 (JP) 2006-130967

(51) Int. Cl. H04W 36/00

(52) U.S. Cl. 370/331

(57) ABSTRACT

It is possible to forcibly cause a terminal to perform an inter-system handoff for system control in a region where service areas of a plurality of radio access systems are overlapped. When it is detected that communication resource of the radio base station is insufficient, a communication terminal which can be replaced by a communication using other system is selected and an inter-system handoff is started.

The present application claims priority from Japanese patent application No. 2006-130967 filed on May 10, 2006, the content of which is hereby incorporated by reference into this application.

### TECHNICAL FIELD

The present invention relates to a radio access network for supporting the inter-system handoff.

### BACKGROUND ART

In the International Standardization Organization 3GPP2 on the portable telephone system, the standardization work for the VoIP voice speech service using the EV-DO Rev. A (hereinafter referred to as “Rev.A” ) system constituting the radio access technique for packet communication is under way. The service area of the Rev.A voice speech service is limited to the area where the Rev.A base station is constructed. For this reason, the service area is expected to be limited in spots in the initial stage of construction. According to 3GPP2, the handoff from Rev.A to the 1× system which is the conventional radio access technique for circuit switch is under study to keep the satisfactory operability on the part of the user. In the case where the user who started the voice speech in the Rev.A area moves out of the Rev.A area, the speech can be continued by the inter-system handoff to 1× (3GPP2 Contribution A40-20060111-002r2 “HHO of VoIP on HRPD to 1× Circuit Voice Stage 2/3 Compromise” (Non-Patent Document 1)).

The specific steps are explained with reference to FIG. 11. Assume that a terminal 1101 is in VoIP communication through the access network AN 1102 and the packet control function PCF 1104 (step 1106). The terminal 1101 measures the receiving level of the Rev.A signal transmitted from the AN 1102 and reports the result to the AN 1102 (step 1107). In the case where the reported receiving level is reduced below a predetermined value, the AN 1102 judges that the voice speech with the Rev.A system is difficult to continue and instructs the terminal 1101 to execute the handoff to 1× (step 1108). The terminal 1101 notifies the AN 1102 of the start of handoff to 1× (step 1109). The AN 1102 notifies the PCF 1104. The PCF 1104 transmits a transmission request to the MSC 1105 emulating the base station of the 1× system (step 1110). The MSC 1105 executes the transmission process and transmits the connection notice to the PCF 1104 (step 1111). Next, the PCF 1104 transmits the handoff request between the 1× base stations to the MSC 1105 (step 1112). The PCF 1104 appears to the MSC 1105 as an 1× base station and the terminal 1101 is recognized to be in speech under the control of the particular base station. Therefore, the normal handoff process between the 1× base stations is executed. The MSC 1105 transmits a handoff request to the 1×BS 1103 constituting the 1× base station as a destination (step 1113). The 1×BS 1103 secures the resources of the base station and transmits a response to the handoff request to the MSC 1105 (step 1114). The MSC 1105 transmits a handoff command to the terminal 1101 through the PCF 1104 and the AN 1102 (step 1115). The terminal 1101 establishes the radio link with the 1×BS 1103 (step 1116), and then, the handoff completion is transmitted to the 1×BS 1103 (step 1117). The 1×BS 1103 transmits it to the MSC 1105. In this way, the inter-system handoff from Rev.A to 1× is completed (step 1118).

Another conventional technique on the inter-system handoff is described in Patent Document 1. According to this technique, a high quality system can be selected for communication in an area where plural systems including PDC, PHS and cdma-One are available for use.

The specific steps are explained. A terminal receives the radio signals from plural systems substantially at the same time. The QoS of each system is calculated from the receiving level, etc. and the priority order for use is determined and notified to the base station in communication. The base station in communication recalculates the notified QoS related to itself taking the system resources into consideration and corrects the priority order. Then, the resulting priority order is notified to the border MSC (mobile switching center). This border MSC makes an inquiry to a border MSC of the system highest in QoS order whether a vacant channel is available or not. The border MSC which has received the inquiry specifies, with some means, a base station covering the present position of the terminal in the particular system and makes an inquiry as to the availability of a vacant channel. The result is notified to the inquiring border MSC. In the case where the inquiry result is the absence of a vacant channel, an inquiry is made again to the border MSC of the system next in QoS order. Once a system having a vacant channel is found in this way, the particular system is determined as a handoff target system. The handoff target system sets a communication path from the base station to the border MSC.

Patent Document 2 realizes the inter-system handoff using a technique substantially similar to Patent Document 1 with regard to, for example, W-CDMA, GSM/GPRS and radio LAN. The main difference from JP-A-2001-54168 is the provision of a radio resource management device connected to plural systems. The radio resource management device notifies a terminal, with a measurement control command, of the frequency of the system to be measured in accordance with the present position of the terminal. This facilitates the measurement of the receiving level of the plural systems by the terminal. Also, the radio resource management device has a correspondence table prepared in advance for determining the degree of appropriateness of the terminal and the system for each evaluation item including the receiving level of the terminal, the moving speed, the application and the cell load condition (the degree of appropriateness is 10 for rank 5 in receiving level, for example, in Patent Document 2). The total of the appropriateness degrees calculated for each evaluation item is the communication appropriateness degree of the terminal and the system, and the handoff is carried out to the system largest in this value.

Patent Document 1: JP-A-2001-54168

Patent Document 2: JP-A-2004-349976

Non-Patent Document 1: 3GPP2 Contribution A40-20060111-002r2 “HHO of VoIP on HRPD to 1× Circuit Voice Stage 2/3 Compromise”

### DISCLOSURE OF THE INVENTION

### Problem to be Solved by the Invention

Even in the Rev.A area having a sufficient receiving level, the terminals may be concentrated and the communication of a sufficient quality may be impossible depending on the sector and the time. If the system can forcibly carry out the inter-system handoff of the terminal to 1× in such a case, both the call subjected to handoff and the call retained in the Rev.A system are expected to be improved in quality and hence serviceability.

According to the proposition of 3GPP2, however, the inter-system handoff is carried out by detecting the reduction in Rev.A receiving level and the likelihood of displacement out of the service area. Therefore, the problem is posed that the inter-system handoff cannot be carried out in accordance with the communication load condition within the Rev.A area.

In the technique described in Patent Document 1, on the other hand, the inter-system handoff is started by notifying the priority order of the systems to the base station from the terminal desiring a better system. This poses the problem that the network cannot play the leading role in selecting the terminal for handoff and the handoff cannot be carried out at the intended timing. Also, the fact that the handoff is carried out as requested by the terminal encounters the problem that the inter-system handoff occurs so frequently that the control load of the system is increased. Also, the handoff target system is determined by the border MSC, and the control is independent of the handoff carried out between base stations by the mobile switch in the prior art. The resulting problem is posed that only the intolerable communication quality can be provided after the handoff between base stations, and no responsive measure can be taken to meet the requirement, if any, to restore the communication immediately.

According to the technique described in Patent Document 2, on the other hand, the handoff is started by the transmission of a measurement control command from the radio resource management device in the network to the terminal. The problem is, however, that this process cannot necessarily achieve the intended inter-system handoff. This is because the method of determining the handoff target is based on the degree of communication appropriateness for the terminal involved. Even in the case where the inter-system handoff of the terminal involved would improve the quality of other plural terminals, the improvement is impossible as long as the terminal involved is currently communicating with the optimum base station. Also, since the degree of communication appropriateness is the total of the values calculated for the evaluation items, the correspondence table is required to be tuned in such a manner that the same value receives the same evaluation between the evaluation items in light of the purpose of the inter-system handoff. The problem is that this is very difficult to achieve. Another problem is that this technique is not adapted for the handoff scheme such as the soft handoff in which a terminal uses plural base stations at the same time. This is because in spite of the fact that the requested quality is not required fully by a single base station at the time of starting the soft handoff, a single base station which can meet the quality tends to be selected in the technique described in Patent Document 2. In other words, an unnecessary inter-system handoff occurs.

The object of this invention is to carry out the inter-system handoff of a terminal forcibly for system control in an area where service areas of plural radio access systems are overlapped, i.e. to provide a method of starting the inter-system handoff steps on the initiative of the base station or the access network upon judgment that a sufficient QoS cannot be provided to the terminal in accordance with the state of the communication resources of the base station or the access network connected with the terminal.

### Means for Solving Problem

This invention is characterized in that the base station includes a resource shortage detection means for detecting that the communication resources of a radio base station are in shortage, an inter-system handoff target selection means for selecting, from among the terminals in communication using the radio base station at the time of detection, a terminal for which the communication service currently used can be replaced by the communication service of another radio access system, and an inter-system handoff starting means for carrying out the handoff of the terminal to the aforementioned another radio access system.

### ADVANTAGES OF THE INVENTION

According to this invention, in the case where the communication resources of a base station are in short supply, the handoff of a specified terminal to another system can be carried out forcibly at the discretion of the base station. Therefore, the situation in which the terminals are so concentrated in the Rev.A service area that the satisfactory communication quality cannot be obtained for the terminals connected to the Rev.A base station can be positively avoided. Also, since the inter-system handoff is started at the discretion of not the terminal but the base station, the occurrence of the inter-system handoff can be suppressed to the required minimum. In the soft handoff state in which a terminal communicates with plural base stations, the inter-system handoff is not started before the degree of dependency on the target base station increases also in the case where the communication resources in the target base station cannot be sufficiently secured. In the case where the terminal in handoff mode is expected to return finally to the source base station, therefore, the inter-system handoff is saved. Also, whenever it is desirous of blocking the base station, the handoff of the terminal in communication can be carried out to another system, and therefore, the base station can be quickly blocked. Further, the inter-system handoff carried out for other than a specified type of communication makes it possible to use the base station only for the TV phone, for example.

The other objects, features and advantages of the invention will be made apparent by the description of embodiments of the invention below taken in conjunction with the accompanying drawings.

### BEST MODE FOR CARRYING OUT THE INVENTION

First, a mobile communication system to which the invention is applicable is explained with reference to FIG. 2. A terminal 101 can be used by two radio access systems. One is a 1× system configured of a BSC (base station controller) 212 and a BTS (base transceiver system) 105. The 1× system makes up a service area 202. The BSC 212 is connected to a mobile switching center (MSC) 213. The terminal 101, the BTS 105, the BSC 212 and the MSC 213 constitute a portable telephone system of circuit switch type.

The other radio access system is a Rev.A system configured of a PCF (packet control function) 104 and an AN (access network) 102. The Rev.A system forms the service area 201. The AN 102 may be packaged as plural units such as an access network base station AN-BTS 203 and an access network base station host station AN-BSC 204. The AN-BTS 203 terminates the radio physical layer. The AN-BSC 204 terminals the radio link layer. They correspond to the BTS 105 and the BSC 212, respectively, of the 1× system. The AN 102 and the AN-BSC 204 are connected to the PCF 104. The PCF 104 is connected to the PDSN (Packet Data Serving Node) 205. The PDSN 205 establishes the PPP link with the terminal 101 to authenticate the user and collect the accounting information. In accordance with the radio link state, the PCF 104 buffers the packet addressed to the terminal 101 that has been received from the PDSN 205, as required. The SIP 206 is a call control server for VoIP communication. The terminal 101, the AN 102, the PCF 104, the PDSN 205 and the SIP 206 make up a portable telephone system of VoIP type.

The portable telephone system of VoIP type and the portable telephone system of circuit switch type are connected to each other through a gateway (GW) 210. Also, the portable telephone system of VoIP type is connected to a fixed telephone system through the GW 207. The fixed switch (LS: Local Switch) 208 accommodates the fixed terminal 209. The GW 207, 210 convert/invert the circuit switch signaling and the bearer to the SIP signaling and the VoIP bearer. The terminal 101 is assumed to correspond to plural systems and capable of communication either by VoIP or circuit switch. The same portable telephone provider provides the service using both systems, and the terminals are collectively managed by this provider. Therefore, the provider can provide the service to the terminals using either system.

Now, assume that the terminal 101 is in communication with a fixed terminal 209 using the Rev.A system. The communication path is formed of the terminal 101, the AN 102, the PCF 104, the PDSN 205, the GW 207, the LS 208 and the fixed terminal 209. Under this condition, this invention starts the inter-system handoff in the case where the communication resources run short or become unusable for some reason. Upon execution of the inter-system handoff, the communication path between the terminal 101 and the fixed terminal 209 is formed not through the Rev.A system but through the 1× system, i.e. the terminal 101, the BTS 105, the BSC 212, the MSC 213, the GW 210, the GW 207, the LS 208 and the fixed terminal 209.

Next, the configuration of the AN 102 is shown in FIG. 6. The radio wave transmitter/receiver 601 executes the radio RF process. The baseband processing unit 602 extracts the packet data from the signal digitized by the radio wave transmitter/receiver 601. The packet transfer/signaling processing unit 603 analyzes the packet data and, if it is the control signal, performs the radio control or signaling control, or if it is the user data, transmits it to the wired circuit terminal unit 604 for transfer to the PCF 104. The wired circuit terminal unit 604 processes the data link layer and the physical layer of the wired circuit and transmits and receives the packet to and from the PCF 104. The resource management unit 605 manages the state of the communication resources of the AN 102, and in accordance with the command from the handoff control unit 606, secures and releases the resources. FIGS. 7 and 8 are tables managed by the resource management unit 605.

FIG. 7 shows a traffic condition table 700 indicating the traffic condition of the AN 102. The total received electric energy 701 indicates the total electric energy received from all the terminals (including both the terminals connected only to the AN 102 and the terminals in the process of soft handoff) connected to the AN 102. In the case where this value exceeds the threshold (say, 7 dB) at which stable radio communication can be performed, the communication of a new terminal is not accepted. The total constant bit rate (upstream) 702 and the total constant bit rate (downstream) 703 indicate the degree to which the upstream or downstream bandwidth, as the case may be, is consumed by the communication requiring the fixed bandwidth. In the case where the threshold value set by the operator is exceeded, a new constant bit rate communication is not accepted. The best effort flow number 704 indicates the number of the best effort flows through the AN 102. In the case where the threshold value set by the operator is exceeded, a new constant bit rate communication is not accepted to prevent the best effort communication from being suppressed any more.

FIG. 8 shows a QoS control state table 800. This is the number of flows (including both the terminals in handoff mode and not in handoff mode) counted per unit time, which require the QoS control and which have failed to be controlled. The table is formed of a delay time 801, a jitter 802 and a bandwidth 803. The delay time 801 indicates the number of excess flows in which the time from the receipt to transmission of user packets by the AN 102 exceeds the tolerance determined for each flow. FIG. 8 shows a case in which there are 20 flows with a predetermined delay tolerance and 10 flows with the tolerance exceeded for the immediately preceding unit time. The jitter 802 indicates the number of excess flows in which the fluctuation of time from the receipt of the user packets by the AN 102 to the transmission thereof exceeds the tolerance determined for each flow. FIG. 8 shows a case in which out of 15 flows for which the jitter tolerance is determined, 9 have failed to achieve the target for the immediately preceding unit time. The bandwidth 803 indicates the number of flows that have failed to achieve the tolerable lowest bandwidth determined for each flow during the immediately preceding unit time. FIG. 8 shows a case in which none of 15 flows for which the tolerable lowest bandwidth is determined is lower than the tolerable lowest bandwidth.

Let us return to FIG. 6. The handoff control unit 606 of the AN 102 determines the handoff execution based on the situation of the communication resources, and transmits a signaling for handoff such as a 1× handoff command to the terminal. The system management unit 607 conducts the health check of the AN 102 as a whole and has an interface with the maintenance device 608. The maintenance device 608 is a terminal used by the operator for the maintenance work of the AN 102. The AN 102 and the maintenance device 608, though connected directly to each other in this embodiment, may alternatively be connected to each other through a communication network.

Next, an example of starting the inter-system handoff is explained with reference to the sequence diagram of FIG. 1. This example shows a case in which at the time of inter-AN handoff in the Rev.A system by the terminal 101, the AN at the handoff target has failed to secure the communication resources. The AN at the handoff source is designated as a source AN 102s and the AN at the handoff target as a target AN 102t. Assume that the terminal 101 is in speech with the fixed terminal 209 through the AN 102s and the PCF 104 (step 106). Once the radio receiving level from the target AN 102t exceeds a predetermined value, the terminal 101 transmits the handoff start message, i.e. the Route Update to the source AN 102s (step 107). The source AN 102s transmits a handoff request to the target AN 102t (step 108). In the process, the requirement of QoS for voice speech is notified. The target AN 102t executes the resource situation judging process (step 109).

FIG. 3 shows a flowchart for the resource situation judging process 109. This process is executed by the resource management unit 605. First, step 301 judges whether the communication for handoff is a call type of which the acceptance is prohibited or not. In the areas such as sight-seeing spots where demand for photo mail and TV phone is high, for example, the Rev.A may not be desired for the voice speech call. In such a case, by setting the voice speech call in advance as a prohibited call type in the AN 102, the result of judgment in step 301 can be led to no resource vacancy (step 307).

In the case where a call is judged not as the acceptance prohibited type in step 301, whether the total received electric energy 701 in the traffic condition table of FIG. 7 is judged to be less than a threshold value or not (step 302). In the case where the total received electric energy 701 is not less than the threshold value, the radio communication control of the AN 102 becomes unstable at the time of handoff acceptance, and therefore, the state is set as no resource vacancy (step 307). In the case where the total received electric energy 701 is less than the threshold value, on the other hand, whether the total constant bit rate (upstream) 702 and downstream (703) in the traffic condition table is judged to be less than the threshold value or not (step 303). In the case where the total constant bit rate (upstream) 702 and (downstream) 703 is not less than the threshold value, the state is set at no resource vacancy by judging that the bandwidth is not available for the incoming terminal for handoff (step 307). In the case where the total constant bit rate (upstream) 702 and (downstream) 703 is less than threshold value, on the other hand, whether the number of the best effort flows 704 in the traffic condition table is less than the threshold or not (step 304). In the case where the number of the best effort flows 704 is not less than the threshold, the bandwidth for the incoming terminal for handoff is judged as not available, the state is set to no resource vacancy (step 307). In the case where the number of the best effort flows 704 is less than the threshold, whether the number of flows for which the QoS control has failed in the QoS control state table of FIG. 8 is less than the threshold or not is judged. In the case where the threshold is exceeded, the QoS of the existing flow is judged to reach an intolerable level if the incoming terminal for handoff is accepted, and the state is set at no resource vacancy (step 307). In the case where the number of such flows is less than the threshold value, on the other hand, the resources for the incoming terminal for handoff are judged as available (step 306).

Returning to FIG. 1, in the case where no vacant resource is available as the result of step 109, the resources cannot be secured for the terminal 101 (step 110). The target AN 102t transmits the handoff response indicating the resource acquisition failure to the source AN 102s (step 111). This establishes the handoff communication path between the target AN 102t and the source AN 102s. Since the target AN 102t cannot secure the resources, however, the QoS control for communication of the terminal 101 is not performed (although the service quality is not guaranteed, the connection of the terminal is permitted). The source AN 102s that has received the handoff response transmits a communication channel assignment completion “Traffic Channel Assignment” to the terminal 101, indicating that the target AN 102t has become communicable with the terminal 101 (step 112). Then, the terminal 101 assumes the handoff mode. Specifically, the terminal 101 reselects in real time the the source AN 102s or the target AN 102t, whichever is higher in receiving quality, and conducts radio communication with the AN thus selected. The terminal 101 notifies the source AN 102s of the selected AN information using the information called the DRC (Data Rate Control) cover. In the case where the DRC cover indicates the source AN 102s, the source AN 102s conducts radio communication with the terminal 101 in the same manner as before the handoff (step 113a). In the case where the DRC cover indicates the target AN 102t, however, the terminal-addressed packet received from the PCF 104 is transferred to the target AN 102t and transmitted by radio from the target AN 102t to the terminal 101. Also, the packet received by the target 102t from the terminal 101 is transferred to the source AN 102s, which in turn transmits it to the PCF 104 (step 113b). In handoff mode, therefore, the communication through the target 102t is made possible at the discretion of the terminal. In the case where the resources for the terminal 101 are not secured, the target 102t executes the process for the handoff terminal resource acquisition failure process step 114.

FIG. 4 is a flowchart for the handoff terminal resource acquisition failure process 114. This process is executed by the handoff control unit 606 of the AN 102. First, in order to create a resource vacancy, the terminal intended for inter-system handoff is selected (step 401). In this case, such a terminal is selected by reference to the flow state table of FIG. 10.

FIG. 10 is explained. This table is managed by the resource management unit 605 of the target AN 102t and provided for each terminal. The 1× handoff 1006 indicates whether the communication of the terminal corresponding to the table can be replaced by the communication utilizing the 1× system. This information is set based on the service type (voice speech, etc.) at the time when the terminal starts the communication through the AN thereof. The QoS control failure number 1005 per unit time indicates the number of times the QoS control has failed in the communication of the terminal corresponding to the table. The delay time 1001 indicates the number of packets for which the time required to pass the AN 102 exceeds the target value. The jitter 1002 indicates the number of packets for which the fluctuation of the time required to pass through the AN 102 exceeds the target value. The bandwidth 1003 indicates the number of time zones in which the target lowest bandwidth cannot be met, of all the plural zones into which the unit time is further divided. The handoff fluctuation rate 1004 indicates the number of times the DRC cover changes per unit time with respect to the terminal in handoff mode. Each time the DRC cover of the terminal changes, the AN changes the packet transfer path to the particular terminal. Thus, the greater the number of handoff fluctuations, the heavier the burden on the AN. Also, the terminal is expected to be unable to receive the radio wave sufficiently from any AN and low in communication quality.

Return to FIG. 4. In step 401, first, by referring to the 1× handoff 1006 of the flow state table of each terminal, the terminals for which handoff is OK are selectively determined. From these terminals, the terminal greatest in the QoS control failure number 1005 per unit time is selected. This is by reason of the fact that the terminal large in the QoS control failure number is likely to have a higher communication quality with the 1× system. As another example, the terminals high in the handoff fluctuation rate 1004 are selected. This is by reason of the fact that the terminals high in handoff fluctuation rate have a heavier control load, and the use of the 1× system is likely to reduce the load more. In this way, the terminal in which the service quality provided by the Rev.A system is not very high or the terminal heavy in control load for the base station or the access network is subjected to handoff in priority.

With regard to the terminal selected in this way as intended for inter-system handoff, the 1× sector of the inter-system handoff target is specified from the position of the AN 102, etc. (step 403). Then, the steps of inter-system handoff are started (step 404). Specifically, the 1× handoff command of FIG. 11 is transmitted to the terminal 101 by the AN 102, so that the inter-system handoff steps studied by 3GPP2 are started. As to the terminal 101 which could not secure the resources in handoff mode after a margin developed in the communication resources as the result of inter-system handoff of a part of the connected terminal, whether it is still in handoff mode or not as of this timing is judged (step 405). If such a terminal is in handoff mode, the resources are secured, and after successfully securing the resources, the resource acquisition success notice is transmitted to the source AN 102s (steps 406, 407). In the case where sufficient resources are not yet available in step 406, the process returns to step 401. Once the terminal 101 in handoff mode yet to secure the resources in step 405 returns to the source AN 102s and leaves the handoff mode, the process is ended.

Let us return to FIG. 1. While the terminal 101 is in handoff mode, the source AN 102s monitors the DRC cover, i.e. which AN is associated with the other party of radio communication of the terminal 101. Once the terminal 101 approaches the target AN 102t sufficiently, the DRC cover ceases to indicate the source AN 102s. In the case where the DRC cover continues to indicate the target AN 102t for the time not less than a given threshold value (step 115), the process proceeds to step 116. Step 116 checks whether the resource acquisition success notice has been received from the target AN 102t or not. In the case where the notice is already received, it indicates that the resources are successfully secured at the target AN 102t, and therefore, the process is executed to separate the source AN 102s from the communication path of the terminal thereby to end the handoff mode (step 117). In the case where the resource acquisition success notice is not yet received in step 116, on the other hand, it indicates that the terminal 101 depends only on the communication through the target AN 102t not subjected to QoS control. Therefore, the 1× sector where the terminal 101 can conduct the radio communication specified from the position of the AN 102t, etc. (step 118), and the inter-system handoff is started (step 119). Specifically, the 1× handoff command of FIG. 11 is transmitted to the terminal 101 by the AN 102, so that the inter-system handoff steps studied by 3GPP2 are started. Once the inter-system handoff succeeds, the terminal 101 conducts voice communication through the BTS 105 (step 120). The source AN 102s transmits the handoff end notice to the target AN 102t (step 121), which in turn transmits the end response to the source AN 102s (step 122).

FIG. 5 is a flowchart showing the process executed when the source AN 102s of FIG. 1 receives the handoff response of the resource acquisition failure (step 111). This is executed by the handoff control unit 606 shown in FIG. 6. First, whether the handoff mode of the terminal 101 is continued or not is judged (step 501). Unless the particular mode is continued, the process is ended. In the case where the mode is continued, on the other hand, whether the DRC cover continues to indicate the target AN 102t or not is judged (step 502). In the case where the target AN 102t is not so indicated continuously, it shows that the terminal communication is not dependent solely on the target AN 102t, and therefore, from the viewpoint of the communication quality of the terminal 101, the inter-system handoff is not yet required. The process proceeds to step 509 to judge whether the fluctuation rate exceeds the threshold value or not (step 509). This is performed by referring to the handoff fluctuation rate 1004 in the flow state table of FIG. 10. In the case where the fluctuation rate is not more than the threshold value, the inter-system handoff is not required also from the viewpoint of the handoff control load, and the process returns to step 501. In the case where the fluctuation rate exceeds the threshold value in step 509, on the other hand, step 510 judges whether the communication of the terminal 101 can be replaced with the 1× communication or not. This is performed by referring to the 1× handoff 1006 in the flow state table of FIG. 10. In the case where the communication cannot be so replaced, the process returns to step 501 without starting the inter-system handoff.

In the case where the communication can be so replaced, on the other hand, the sector where the terminal 101 exists in the 1× system is specified from the position of the target AN 102t, etc. (step 506) and the inter-system handoff is executed (step 507). After that, the handoff end notice is transmitted to the target AN 102t thereby to end the process (step 508). In the case where the DRC cover continues to indicate the target AN 102t in step 502, step 503 judges whether the resource acquisition success notice has been received from the target An 102t or not. In the case where the notice is so received, the handoff process in the Rev.A system is executed (step 504). In the case where the resource acquisition success notice is not yet received in step 503, whether the communication of the terminal 101 can be replaced by 1× or not (step 505). In the case where the particular communication cannot be so replaced, the handoff in the system is executed (step 504) thereby to end the process. In the case where the communication can be replaced by the 1× communication, on the other hand, the process proceeds to step 506, and after specifying the 1× sector, the inter-system handoff is executed.

FIG. 9 is a flowchart of the process of the AN 102 with the block command or the voice service stop command applied to the AN 102 from the maintenance device 608 shown in FIG. 6. This process is executed by the handoff control unit 606 shown in FIG. 6. With the transmission of the block command or the voice service stop command to the handoff control unit 606 through the system management unit 607, the presence or absence of a terminal in communication is first judged (step 901). In the absence of such a terminal, the process for the inter-system handoff is ended. In the presence of such a terminal, on the other hand, whether the communication can be replaced with the 1× communication or not is judged by referring to the 1× handoff 1006 in the flow state table (step 902). In the case where the replacement is impossible, the process returns to step 901 to process the other terminals. In the case where the replacement is possible, on the other hand, the sector at the terminal position in the 1× system is specified (step 903) and the inter-system handoff is carried out (step 904). Then, the process returns to step 901 to process the other terminals. By doing so, the terminals in communication are driven out of the control of the AN 102 as far as possible, so that the AN 102 can be blocked or the voice service thereof stopped rapidly.

FIG. 12 is a flowchart of the AN 102 in the case where the handoff control unit 606 of the AN 102 periodically checks the traffic condition table 700 and the QoS control state table 800 of the resource management unit 605, and the shortage of the communication resources is detected. This configuration is substantially identical with that of the handoff terminal source acquisition failure process 114 shown in FIG. 4. In step 1201, first, referring to the 1× handoff 1006 of the flow state table of each terminal, terminals with handoff OK are selected. Out of these terminals, the terminal having the largest QoS control failure number 1005 per unit time is selected. This is by reason of the fact that the terminal having a large QoS control failure number may be improved in communication quality more by using the 1× system. As another example, the terminals with a high handoff fluctuation rate 1004 are selected. This is because the terminal having a high handoff fluctuation rate has a heavier control load and may be reduced in load by using the 1× system. In this way, the terminals already provided with the service comparatively low in quality by the Rev.A system and the terminals imposing a heavy control load on the base station or the access network are subjected to the handoff operation in priority.

With regard to the terminal selected in this manner for inter-system handoff, the 1× sector of the inter-system handoff target is specified from the position of the AN 102, etc. (step 1203). Then, the inter-system handoff steps are started (step 1204). Specifically, the 1× handoff command shown in FIG. 11 is transmitted to the terminal 101 by the AN 102, so that inter-system handoff steps studied by 3GPP2 are started. Whether each value in the traffic condition table 700 and the QoS control state table 800 is reduced below the threshold value as the result of carrying out the inter-system handoff of a part of the terminals connected is judged (step 1206). In the case where the values are reduced below the threshold, the process is ended. In the case where the values are not reduced below the threshold, on the other hand, the process returns to step 1201.

In the embodiments described above, the inter-system handoff from the Rev.A system to the 1× system is explained. Nevertheless, the handoff from the 1× system to the Rev.A system or to other access systems such as WiMAX can be executed in similar fashion.

Incidentally, the inter-system handoff can be also started by the base station broadcasting to the terminals under the control thereof the fact that the shortage of the communication resources is detected and each terminal judging semi-autonomously whether the inter-system handoff should be carried out based on the expected effect on the other terminals (i.e. the size of the transmission power), the communication quality level (jitter less than the tolerance or not) and the communication service received by the particular base station.

The embodiments are described above. Nevertheless, this invention is not limited to these embodiments, and it is apparent to those skilled in the art that various modifications and alterations can be made without departing from the spirit of the invention and the scope of the appended claims.

### BRIEF DESCRIPTION OF THE DRAWINGS

FIG. 1 is a diagram for explaining the steps of starting the inter-system handoff.

FIG. 2 is a diagram showing the configuration of a mobile communication system to which the invention is applicable.

FIG. 3 is a flowchart for executing the resource situation judging process.

FIG. 4 is a flowchart for executing the handoff terminal resource acquisition failure process.

FIG. 5 is a flowchart for executing the unsecured handoff resource monitoring process.

FIG. 6 is a diagram showing the configuration of a radio base station.

FIG. 7 is a diagram for explaining the traffic condition table managed by the radio base station.

FIG. 8 is a diagram for explaining the QoS control state table managed by the radio base station.

FIG. 9 is a flowchart for executing the inter-system handoff starting process in the blocking process.

FIG. 10 is a diagram for explaining the flow state table managed by the radio base station.

FIG. 11 is a diagram for explaining the inter-system handoff steps studied by 3GPP2.

FIG. 12 is a flowchart for executing the inter-system handoff starting process in the case where the resource shortage is detected by the periodic check.

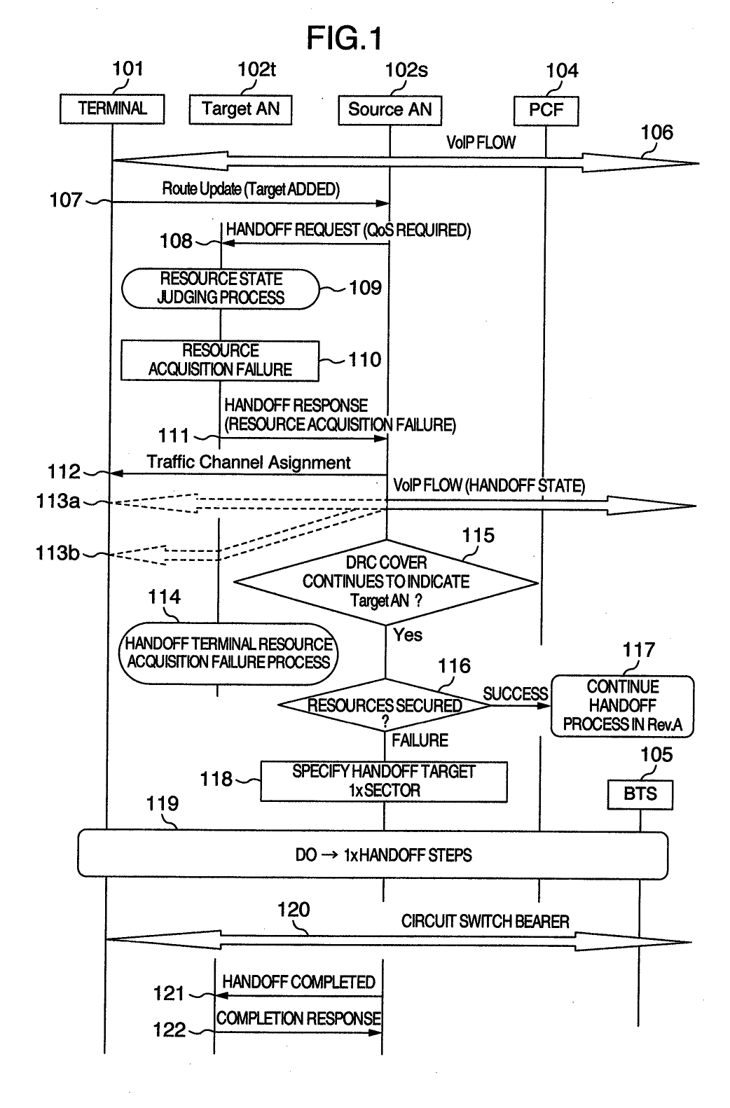

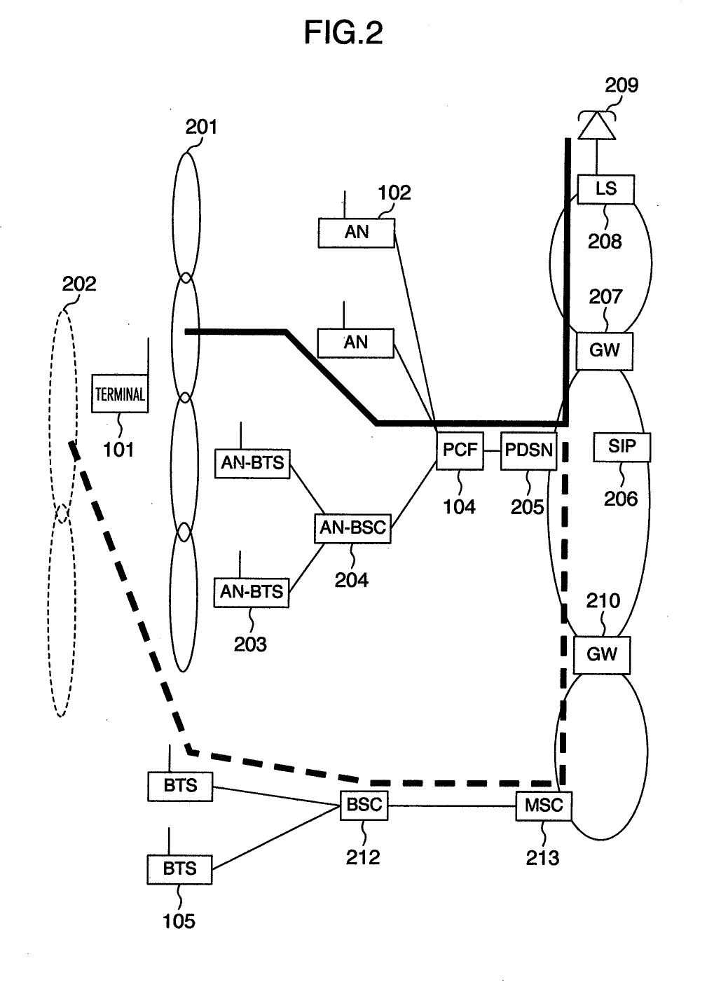

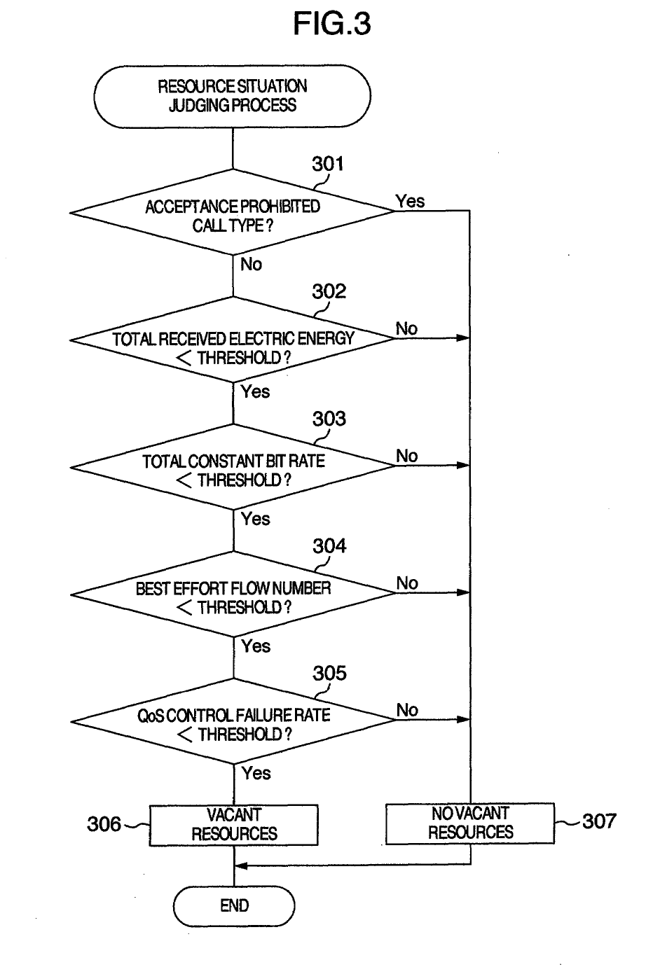

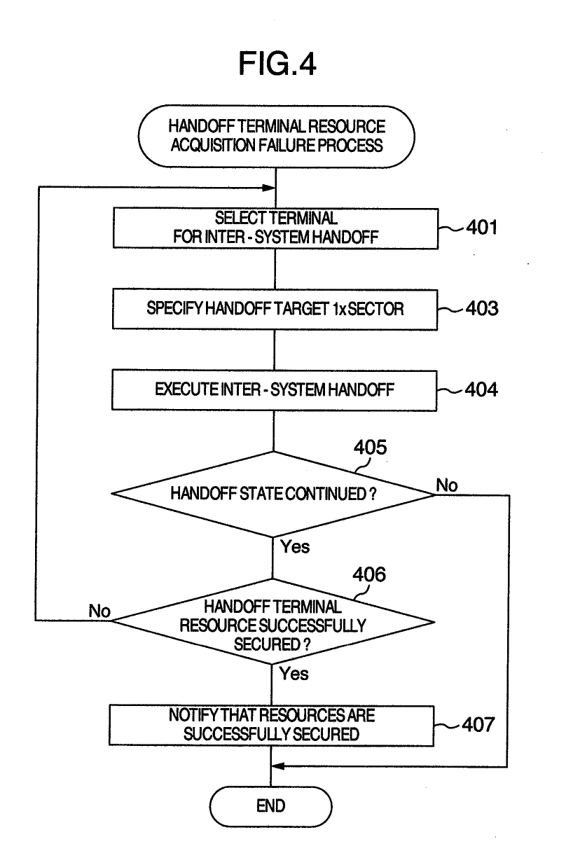

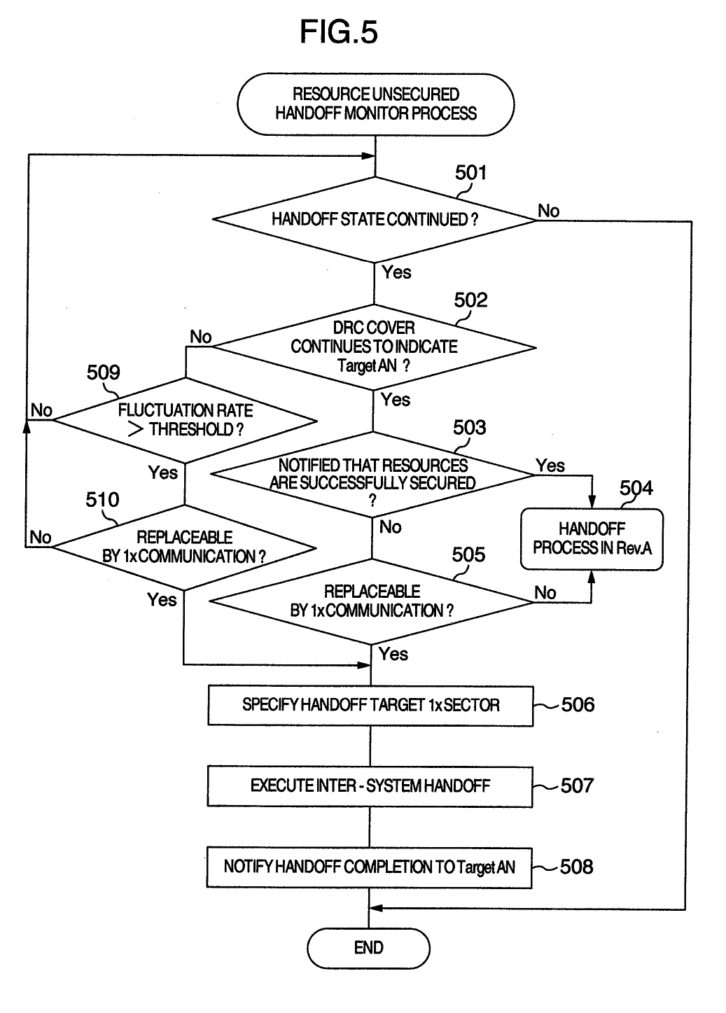

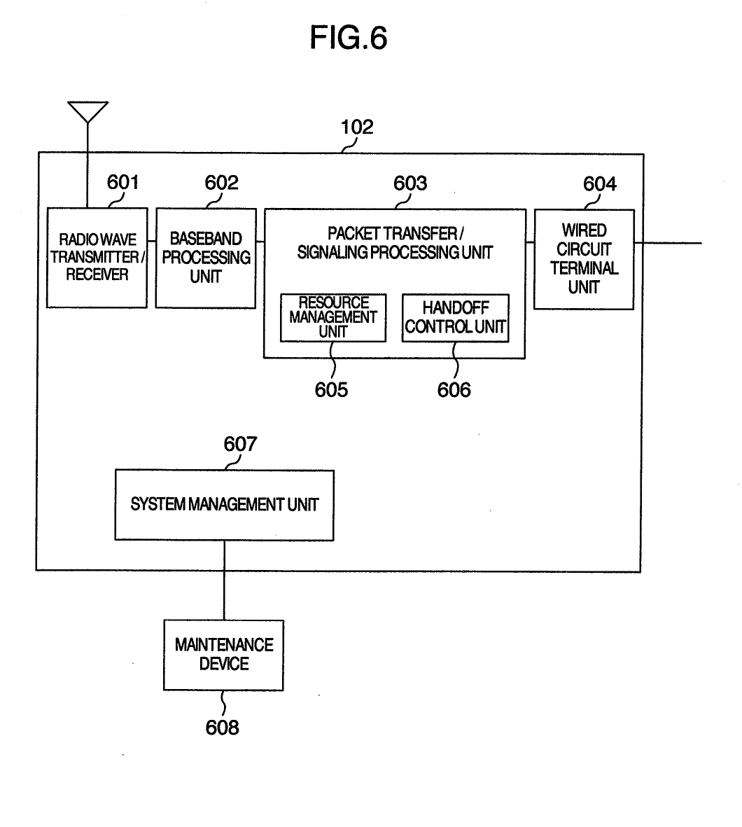

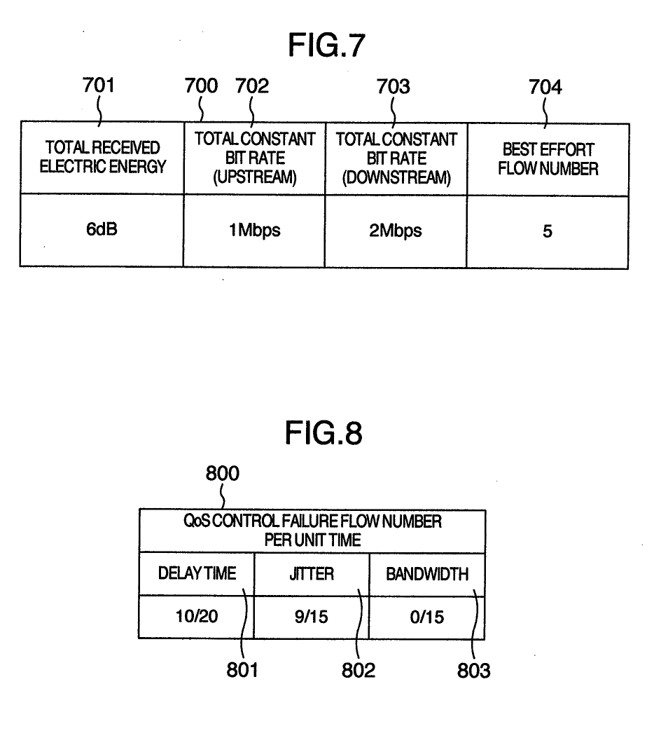

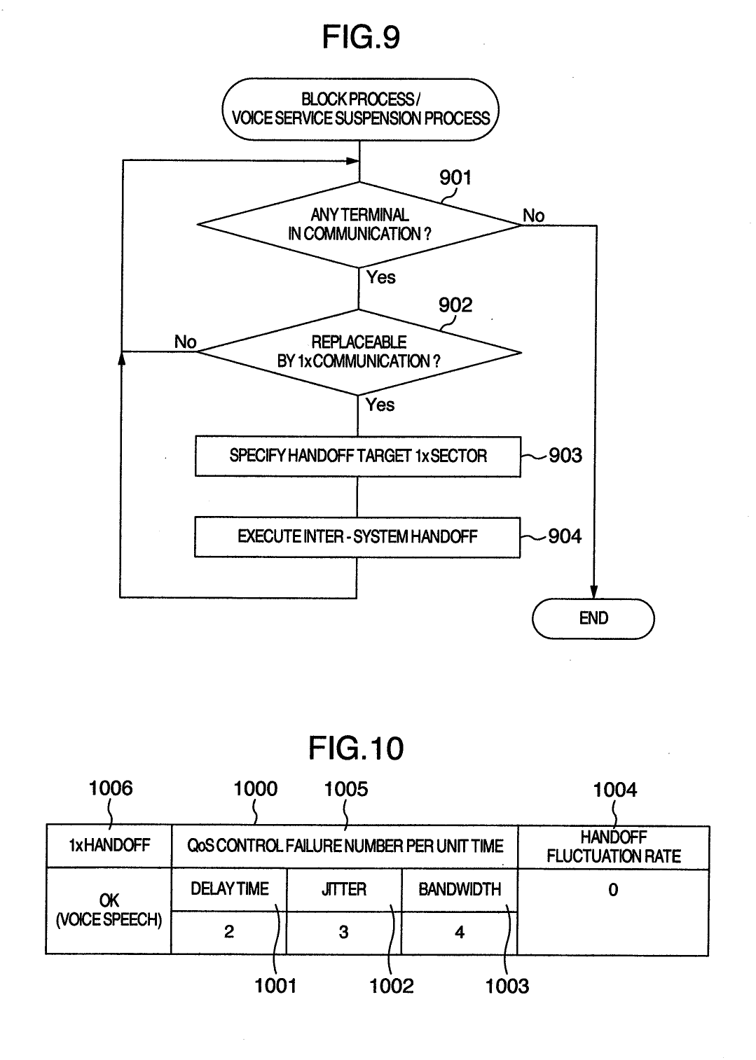

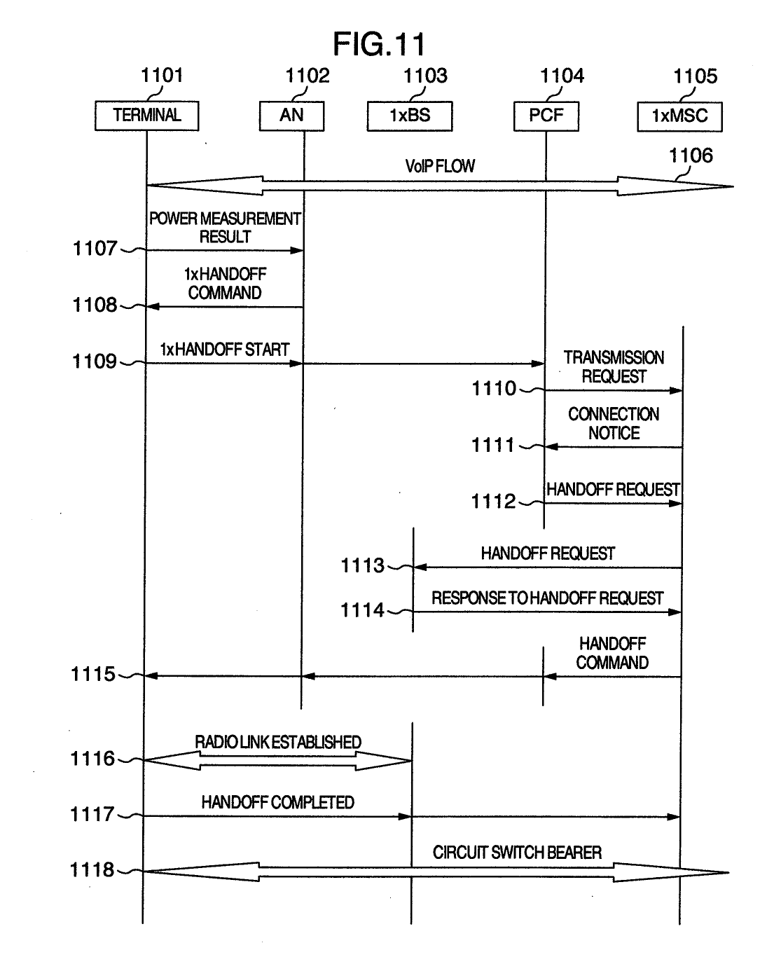

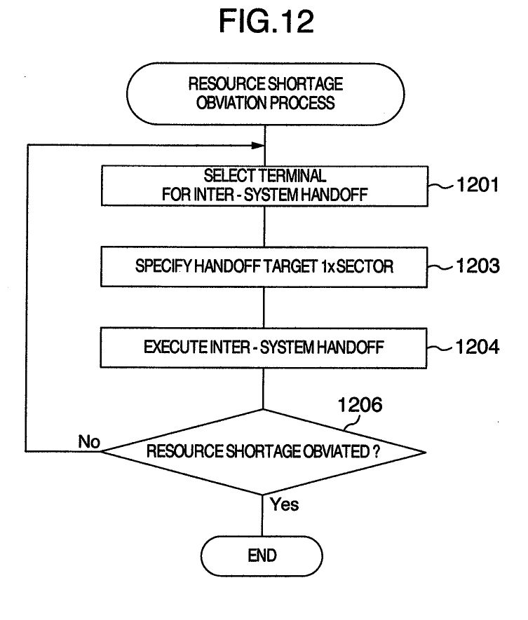

### DESCRIPTION OF REFERENCE NUMERALS

101 Terminal
102t Handoff target radio base station
102s Handoff source radio base station
109 Resource situation judging process
114 Handoff terminal resource acquisition failure process
605 Resource management unit
606 Handoff control unit
700 Traffic condition table
800 QoS control state table
1000 Flow state table

1. In a mobile communication system with service areas overlapped and accommodating a first radio access system and a second radio access system for conducting different types of communication, a radio base station for the first radio access system, characterized by comprising:
a resource management unit for storing the communication resource state of the radio base station; and
a handoff control unit for starting the inter-system handoff by detecting, with reference to the resource management unit, the shortage of the communication resources of the radio base station to conduct the radio communication with plural terminals, and upon detection of the shortage of the communication resources, selecting a terminal using the communication service replaceable with the communication service of the second radio access system, from among the terminals communicating using the radio base station, and carrying out the handoff of the selected terminal to the second radio access system.

2. The radio base station as set forth in claim 1, characterized in that the handoff control unit, upon reception of a block command from the maintenance device communicating with the radio base station, regards the communication resources as depleted and thus detects the shortage of the communication resources.

3. The radio base station as set forth in claim 1, characterized in that the handoff control unit, upon reception of a command from the maintenance device communicating with the radio base station to suspend a specific communication service, regards the communication resources as depleted and thus detects the shortage of the communication resources.

4. The radio base station as set forth in claim 1, characterized in that the handoff control unit judges that the communication resources are in shortage in the case where the number of QoS control failures per unit time at the radio terminal exceeds a predetermined threshold value.

5. The radio base station as set forth in claim 1, characterized in that the handoff control unit selects, as a terminal for inter-system handoff, a terminal of which the number of handoffs per unit time has exceeded a predetermined threshold value.

6. The radio base station as set forth in claim 1, characterized in that the handoff control unit selects, as a terminal for inter-system handoff, a terminal of which the number of QoS control failures per unit time has exceeded a predetermined threshold value.

7. The radio base station as set forth in claim 1, characterized in that the handoff control unit starts the inter-system handoff upon detection of the shortage of the communication resources of a single radio base station communicating with plural radio base stations in the case where a terminal transfers from the soft handoff state communicating with plural radio base stations to the state communicating with the particular single radio base station.

8. The radio base station as set forth in claim 1, characterized in that the handoff control unit judges whether the communication resources are in shortage or not using, as a trigger, the handoff of a terminal communicating with another radio base station associated with the first radio access system to the radio base station of the handoff control unit.

9. The radio base station as set forth in claim 1, characterized in that the handoff control unit judges periodically whether the communication resources are in shortage or not.

10. In a mobile communication system with service areas overlapped and accommodating a first radio access system and a second radio access system for conducting different types of communication, the first radio access system characterized by comprising:
a resource shortage detection means for detecting the shortage of the communication resources for the radio base station of the first radio access system to conduct the radio communication with plural terminals;
an inter-system handoff object selection means for selecting, upon detection of the communication resource shortage, a terminal using the communication service replaceable with the communication service of the second radio access system, from among the terminals in communication using the radio base station; and
an inter-system handoff starting means for carrying out the handoff of the selected terminal to the second radio access system.

11. The radio access system as set forth in claim 10, characterized in that the resource shortage detection means regards the communication resources as depleted and thus detects the shortage of the resources upon reception of a block command from the maintenance device communicating with the radio base station.

12. The radio access system as set forth in claim 10, characterized in that the resource shortage detection means judges that the resource shortage is detected upon reception of a command from the maintenance device communicating with the radio base station to suspend a specific communication service.

13. The radio access system as set forth in claim 10, characterized in that the resource shortage detection means judges that the communication resource shortage is detected in the case where the number of the QoS control failures per unit time exceeds a threshold value.

14. The radio access system as set forth in claim 10, characterized in that the inter-system handoff object selection means selects a terminal of which the number of handoffs per unit time exceeds a threshold value.

15. The radio access system as set forth in claim 10, characterized in that the inter-system handoff object selection means selects a terminal of which the number of QoS control failures per unit time exceeds a threshold value.

16. The radio access system as set forth in claim 10, characterized in that the resource shortage detection means starts the inter-system handoff upon detection of the shortage of the communication resources of a single radio base station in the case where a terminal transfers from the soft handoff state communicating with plural radio base stations to the state communicating with the particular single radio base station.

17. The radio access system as set forth in claim 10, characterized in that the resource shortage detection means judges whether the communication resources are in shortage or not using, as a trigger, the handoff of a terminal communicating with the first radio base station associated with the first radio access system to the second radio base station.

18. In a mobile communication system with service areas overlapped and accommodating a first radio access system and a second radio access system for conducting different types of communication, an inter-system handoff starting method characterized by comprising:
a first step for measuring the state of the communication resources of each radio base station;
a second step for detecting, based on the communication resource state of the each radio base station, the shortage of the communication resources for the radio base station to conduct the radio communication with plural terminals;
a third step for selecting, upon detection of the communication resource shortage, a terminal which is in communication using the radio base station and which uses the communication service replaceable with the communication service of the second radio access system; and
a fourth step for starting the inter-system handoff of the selected terminal to the second radio access system.
